(19) United States
(12) Patent Application Publication
(10) Pub. No.: US 2009/0136226 A1
(43) Pub. Date: May 28, 2009

(54) Camera with photo tracklog producing function and method for producing photo tracklog

(76) Inventors: Shie-Ching Wu, Sanchong City (TW); Kuo-Hung Liao, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/071,612

(22) Filed: Feb. 25, 2008

(30) Foreign Application Priority Data
Nov. 28, 2007 (TW) 96145120

(51) Int. Cl. G03B 17/24; H04N 5/228

(52) U.S. Cl. 396/321; 348/222.1; 348/E05.031

(57) ABSTRACT

A camera with a photo tracklog producing function includes an image recording module used to take digital images; a GPS (Global Positioning System) module used to receive order sequence of positioning data coordinating the measurements of GPS as GPS tracklogs; a processor unit which writes the positioning data in the format for digital images and combines digital images with the GPS tracklogs to produce the corresponding photo tracklog. Users can recognize the traveling track by reviewing the photo tracklogs. The photo tracklogs also show information of the digital images taken along the traveling track. Furthermore, the invention provides a method for producing photo tracklogs.

### BACKGROUND OF THE INVENTION

1. Field of the Invention

The invention generally relates to a camera and a method of producing tracklog, and particularly to a camera which offers tracklog combined with photos that have been taken (photo tracklog), and a method of producing the photo tracklog.

2. Description of the Related Art

Digital cameras have become more and more popular as they are made more and more powerful and multifunctional while being offered competitive prices. One of the popular functions in the novel digital camera is to offer services by the global positioning system (GPS). For example, TW publication no. 200710771, published on Mar. 16, 2007, discloses a GPS device with picture recording function. This device shows geographic information (such as name of the location, and the longitude and latitude) where the geographic information is shown in pictures drawn onto the digital photographs. The images tagged with relevant geographic information are referred to as geotagged photos which help the viewer to recall the memory the moment the pictures are taken.

A commercially available GPS device inherently records the longitudes and the latitudes at different locations for the user in a certain period of time, and then transforms those records into a GPS tracklog accordingly for the user to view his travel track.

However, the devices which only serve to show the GPS tracklog, and those only serving to generate geotagged photo have not met the requirements of multifunctional digital trends.

Therefore, there is a need of a novel digital camera which combines geotagged photos with a GPS tracklog for the user to conveniently refer to the geographic information and positioning data while viewing the digital images.

### SUMMARY OF THE INVENTION

It is an object of the invention to provide a camera with a photo tracklog producing function and to provide a method of producing photo tracklog, in which each digital image is combined with its corresponding GPS tracklog to obtain a photo tracklog so that the user can recall the traveling track by reviewing only the photo tracklog or the digital images along with their corresponding photo tracklog.

In order to achieve the objectives of the above and others, a camera with a photo tracklog producing function according to the invention includes: an image recording module, used to take digital images; a Global Positioning System (GPS) module, used to receive ordered sequences of positioning data coordinating the measurements of GPS as a GPS tracklog; a processor unit, connecting the image recording module to the GPS module, wherein the processor unit writes geographic information in an exchangeable image file format for digital images and then combines the digital images with the GPS tracklog to obtain a photo tracklog; and a storage module, used to connect to the processor unit for storing the digital images, the GPS tracklog and the photo tracklog.

The invention further provides a method of producing photo tracklog. The method includes providing a GPS module to catch positioning data where the user locates at the pre-set periods of time, and writing the obtained positioning data in an ordered sequence into a GPS tracklog file; using an image recording module to take digital images; catching the positioning data of the locations where the images are taken by using the GPS module and writing the corresponding longitude and latitude in an exchangeable image file format for digital images; and adding the positioning data into the GPS tracklog file, tagging each of the positioning data with a photo track mark to obtain a photo tracklog.

The invention offers advantages over the prior art. For example, the photo tracklog combine the digital images with the GPS tracklog. The users can recall the travel track from the photo tracklog, and view the digital images along with the relevant geographic information by clicking the corresponding photo track marks.

To provide a further understanding of the invention, the following detailed description illustrates embodiments and examples of the invention, this detailed description being provided only for illustration of the invention.

### BRIEF DESCRIPTION OF THE DRAWINGS

FIG. 1 is a block diagram of a camera with photo tracklog producing function according to one embodiment of the invention;

FIG. 2 is a graph of photo tracklog according to one embodiment of the invention;

FIG. 3 is a flow chart of a method of producing photo tracklog according to one embodiment of the invention; and

FIG. 4 is a schematic view of a data window of one of photo track marks according to one embodiment of the invention.

### DETAILED DESCRIPTION OF THE EMBODIMENTS

Wherever possible in the following description, like reference numerals will refer to like elements and parts unless otherwise illustrated.

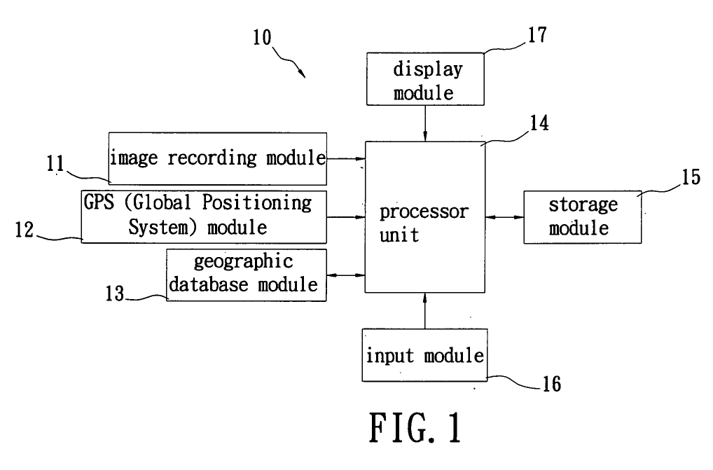

FIG. 1 is a block diagram of a camera with photo tracklog producing function according to one embodiment of the invention. The camera 10 of the invention includes an image recording module 11; a GPS (Global Positioning System) module 12; a geographic database module 13, a processor unit 14, a storage module 15, an input module 16 and a display module 17. The processor unit 14 connects the modules 11, 12, 13, 15, 16 and 17 so as to receive and transmit data to the corresponding modules 11, 12, 13, 15, 16 and 17.

The image recording module 11 is used to take images. The image recording module 11 further has an image sensor to transform the taken images into digital form. The sensor can be, for example, a complementary metal-oxide-semiconductor (CMOS) or a charge-coupled device (CCD). The digital images are transmitted to the processor unit 14 for further processing.

The GPS module 12 is used to receive ordered sequences of positioning data coordinating the measurements of GPS as a GPS tracklog. The positioning date includes the information of longitude and latitude where the images are taken and the time when the images are taken. The GPS module 12 catches a positioning signal according to the time period the user sets and then writes the positioning signal in ordered sequence into a GPS tracklog file. The GPS tracklog file is then saved in the storage module 15 via the processor unit 14.

When the user takes the photos by using the image recording module 11, the GPS module 12 catches positing data (the longitude and the latitude) where the images are taken and then writes the positioning data in an exchangeable image file format for digital images so that the taken images can be transformed into geotagged photos. In addition to the positioning data, the geographic database 13 and the input module 16 can further add the information thereof into the geotagged photos.

The geographic database 13 stores geographic information related to various locations in relation to their longitude and latitude, for example, names of streets, cities, landmarks or scenic spots. When the longitude and the latitude of taken images are confirmed, the processor unit 14 will check the relevant geographic information correlating to the geographic database 13. The obtained relevant geographic information will be written in an exchangeable image file format for digital images.

The input module 16 additionally adds text notes to the digital images after the images are taken. The text notes are also written in an exchangeable image file format for digital images. The input module 16 can be any kind of human machine interfaces such as a touch panel or a keyboard. Then the digital images with the above information are stored into the storage module 15. The storage module 15 in this embodiment of the invention can be a memory card. Files or images stored in the storage module 15 can be transmitted to other devices such as personal computer or digital frames.

Finally, the processor unit 14 combines the digital images with the GPS tracklog to form a photo tracklog. The display module 17 shows the digital images along with the photo tracklog to the user. The photo tracklog can be graphically displayed in the display module 17.

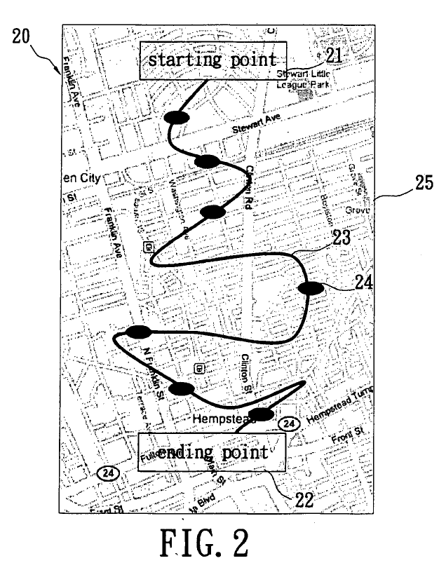

FIG. 2 is a graph of photo tracklog according to one embodiment of the invention. The photo tracklog graph 20 can be shown on the display module 17, output to a personal computer, or uploaded to internet for others to download. The photo tracklog graph 20 includes a starting point 21 and an ending point 22, respectively representing a starting location where the user turns on the GPS module 12 and an ending location where the user turns off the GPS module 12. A GPS tracklog line 23 is formed by connecting all points of the GPS tracklog. The user can recall the traveling track by reviewing only the photo tracklog or the digital images along with their corresponding photo tracklog. The GPS tracklog line 23 has a plurality of photo track marks 24 each of which indicates the presence of one or more taken images. Therefore the user could notice where he or she has been at a particular time point during travel. Furthermore, the photo tracklog graph 20 can be combined with an electronic map 25 which shows the areas where the longitudes and the latitudes of the photo tracklog define.

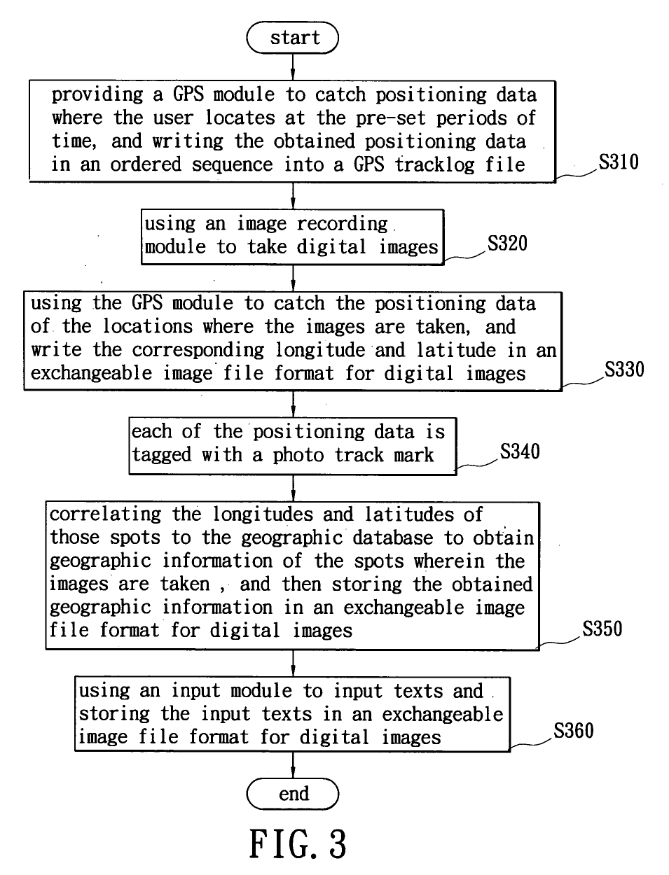

FIG. 3 is a flow chart of a method of producing the photo tracklog according to one embodiment of the invention. Referring to FIG. 3, the method of producing the photo tracklog includes providing a GPS module 12 as shown in FIG. 1 to catch positioning data where the user locates at the pre-set periods of time. The obtained positioning data will be written in an ordered sequence into a GPS tracklog file (S310). Digital images are taken by means of the image recording module 11 (S320). Each time when the images are taken, the GPS module 12 catches the positioning data of the locations where the images are taken and writes the positioning data (corresponding longitude and latitude) in an exchangeable image file format for digital images (S330). Each of the positioning data will be tagged with a photo track mark 24 as shown in FIG. 2 (S340). The geographic information of the spots wherein the images are taken will be obtained by correlating the longitudes and latitudes of those spots to the geographic database. Then the obtained geographic information is stored in an exchangeable image file format for digital images (S350). Texts can be input via an input module to add more information to the corresponding digital images. Those texts can be stored in an exchangeable image file format for digital images (S360).

As such, two types of positioning data are in the GPS tracklog: one is the positioning data with the photo track marks 24 which respectively represent the corresponding digital images, and the other is the positioning data obtained by the GPS module 12. Each of the photo track marks 24 indicates some original information of each corresponding digital image, such as scaled-down image, longitude and latitude where the image is taken, time points when the digital image is taken, geographic information related the location where the digital image is taken, and texts additionally added by the user.

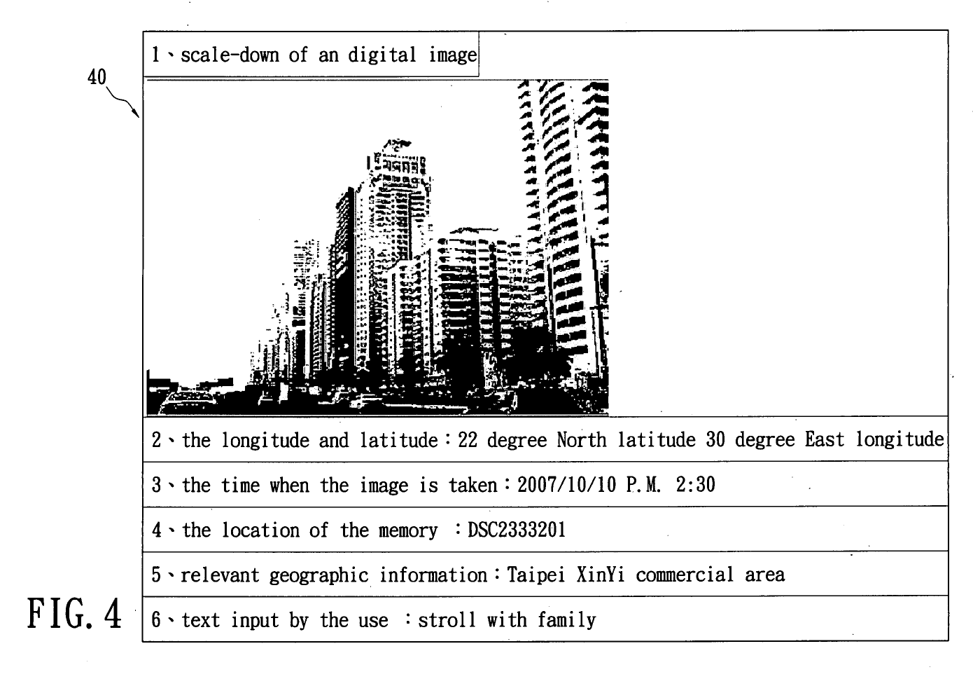

When one of the photo track marks 24 of the photo tracklog graph 20 is clicked, a data window 40 will be opened, as shown in FIG. 4. The user can recall the scenery from his or her memory at that moment correlating to the clicked photo track mark 24 by reading the data provided by the data window 40. Alternatively, the user can review the image frames by opening the original digital image of the clicked photo track mark 24.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A camera with a photo tracklog producing function, comprising
an image recording module, used to take digital images;
a Global Positioning System (GPS) module, used to receive ordered sequences of positioning data coordinating the measurements of GPS as a GPS tracklog;
a processor unit, connecting the image recording module to the GPS module, wherein the processor unit writes geographic information in exchangeable image file format for digital images and then combines the digital images with the GPS tracklog to obtain a photo tracklog; and
a storage module, connected to the processor unit for storing the digital images, the GPS tracklog and the photo tracklog.

2. The camera of claim 1, further comprising a geographic database module connected to the processor unit, wherein the geographic database module stores geographic information from various locations related to their longitude and latitude, and the geographic information includes names of streets, cities, landmarks or scenic spots.

3. The camera of claim 1, further comprising an input module to add text notes to the digital images, wherein the text notes are written in exchangeable image file format for digital images by the processor unit.

4. The camera of claim 1, further comprising a display module to display the digital images and the photo tracklog.

5. The camera of claim 1, wherein the storage module is a memory card.

6. A method for producing photo tracklog, comprising:
providing a GPS module to obtain positioning data from places where the user locates at pre-set periods of time, and writing the positioning data in an ordered sequence into a GPS tracklog file;
using an image recording module to take digital images;
obtaining positioning data of locations where images are taken using the GPS module and writing the corresponding longitude and latitude in an exchangeable image file format for digital images; and
adding the positioning data into the GPS tracklog file, tagging each of the positioning data with a photo track mark to obtain a photo tracklog.

7. The method of claim 6, further comprising:
correlating the longitudes and latitudes of those spots to the geographic database to obtain geographic information of spots where the images are taken; and
writing the geographic information in an exchangeable image file format for digital images.

8. The method of claim 7, further comprising:
inputting texts using an input module; and
writing the texts in an exchangeable image file format for digital images.

9. The method of claim 8, wherein the photo track mark comprises a data window which comprises at least one scaled-down image, longitude and latitude where the image is taken, time points when the digital image is taken, geographic information related the location where the digital image is taken, and texts additionally added by the user.

10. The method of claim 9, wherein the photo tracklog is displayed graphically in a display module.

11. The method of claim 10, wherein data in the storage module is outputted to a personal computer or uploaded to internet.
